(19) United States
(12) Patent Application Publication
(10) Pub. No.: US 2023/0033328 A1
(43) Pub. Date: Feb. 2, 2023

(54) AUTOMATIC EXTRACTION AND CONVERSION FROM CHAT DATA

(71) Applicant: INTUIT INC., Mountain View, CA (US)

(72) Inventor: Satarupa PAL, Bangalore (IN)

(73) Assignee: INTUIT INC., Mountain View, CA (US)

(21) Appl. No.: 17/390,585

(22) Filed: Jul. 30, 2021

(51) Int. Cl. G06F 40/30; G06N 20/20; G06F 40/205

(52) U.S. Cl. CPC G06F 40/30; G06N 20/20; G06F 40/205

(57) ABSTRACT

A processor may receive log data generated by a chat application. The processor may identify at least one positive sentiment in at least one portion of the log data using a first machine learning (ML) process. The processor may also identify content of the at least one portion of the log data relevant to an external application different from the chat application using a second ML process, and/or topic data in the at least one portion of the log data using a third ML process. The processor may form an extraction of the log data that includes at least a portion of the content and at least a portion of the topic data. The extraction may have a format processed by the external application. The processor may export the extraction to the external application.

### BACKGROUND

Chat applications (apps), such as iMessage or Whatsapp, are available on a variety of computing platforms and are used for a variety of communication purposes. In some cases, these purposes include exchanging communications including data that can be recorded and/or used for other purposes. One example is the use of chat by small business owners to conduct day to day business. Indeed, many business transactions happen on chat. For example, one chat app user, who is a prospective buyer, may send a message to another chat app user, who is a prospective seller, asking to know what is in stock. The seller can respond with a list of items available and their prices. The buyer can respond with a request to buy one or more of the items. The parties can agree on the transaction and arrange a time to make the exchange of goods, services, and/or payment. In this way, an entire business transaction can be facilitated using a chat app, and data relevant to that business transaction is now within the chat logs of the users. These logs can be found locally on the respective user computers and/or in a cloud system in communication with the network used by the computers to perform the chat. Other types of chat communications may result in useful data in chat logs in like fashion.

### BRIEF DESCRIPTIONS OF THE DRAWINGS

FIG. 1 shows an example automatic extraction and conversion system according to some embodiments of the disclosure.

FIG. 2 shows an example automatic extraction and conversion process according to some embodiments of the disclosure.

FIG. 3 shows an example sentiment analysis process according to some embodiments of the disclosure.

FIG. 4 shows an example content identification process according to some embodiments of the disclosure.

FIG. 5 shows an example topic modeling process according to some embodiments of the disclosure.

FIG. 6 shows an example training process according to some embodiments of the disclosure.

FIG. 7 shows an example user interface interaction process according to some embodiments of the disclosure.

FIG. 8 shows a computing device according to some embodiments of the disclosure.

### DETAILED DESCRIPTION OF SEVERAL EMBODIMENTS

Chat logs can have data that is useful for other computing processes otherwise unrelated to chat. Embodiments described herein can use several automatic processes, including machine learning (ML) and natural language processing (NLP), to identify relevant data and convert it to data for use in other software. For example, described embodiments analyze chat history, process identified relevant text, and send formatted input to the target software or any other medium. In some embodiments, users can review and approve the results, and data can be synced to the target software. Data thus generated can be used for accounting, record keeping, billing, tracking, and/or any other analysis purpose or software function.

As a non-limiting example, if a business transaction is conducted through chat messages as described above, the chat logs contain data about the transaction. This data can be useful for accounting/financial software (e.g., QuickBooks Online, Mint), record-keeping/spreadsheet software (e.g., Excel), payment processing software, and/or for other purposes. Embodiments described herein can automatically identify transaction data, export it from the chat logs, and import it into other software. Using ML and/or NLP algorithms, disclosed embodiments can identify statements relevant to the transaction, convert information therein to transactional data (e.g., sales items identified with price mentioned, customer identity, payment description, etc.), and provide the data to any application that is able to utilize the data.

The described systems and methods therefore provide both user-oriented and technical improvements. A user can be assured that valuable data is automatically captured from chat logs, without requiring manual search of those logs and manual entry of the data into other software applications. Moreover, the described systems and methods provide a particular suite of ML, NLP, and other techniques that are specifically configured to process chat text. The end result is new data that is directly useable with other software for its own processing without further modification or user input.

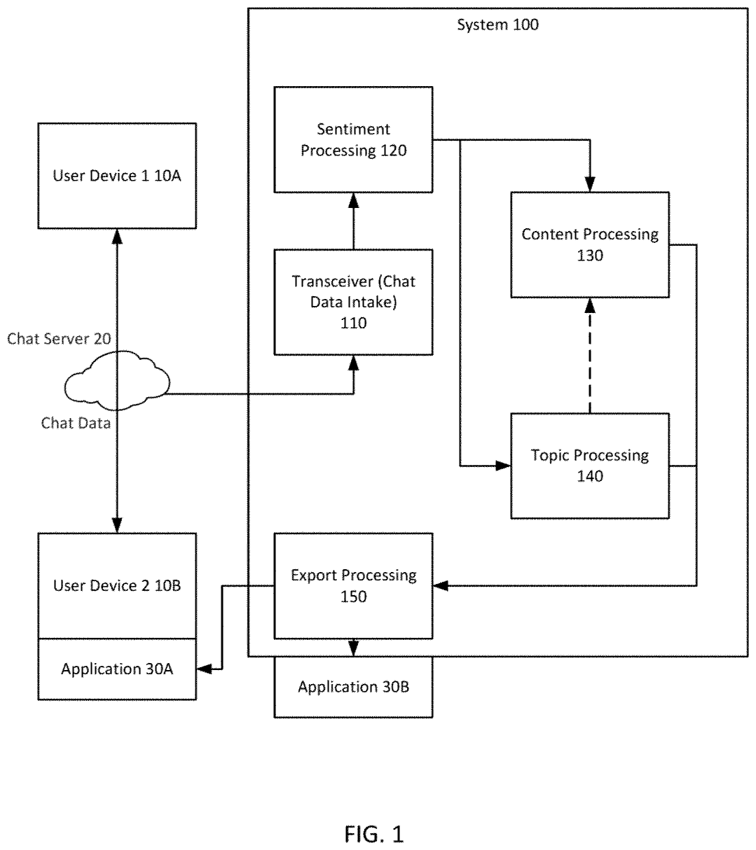

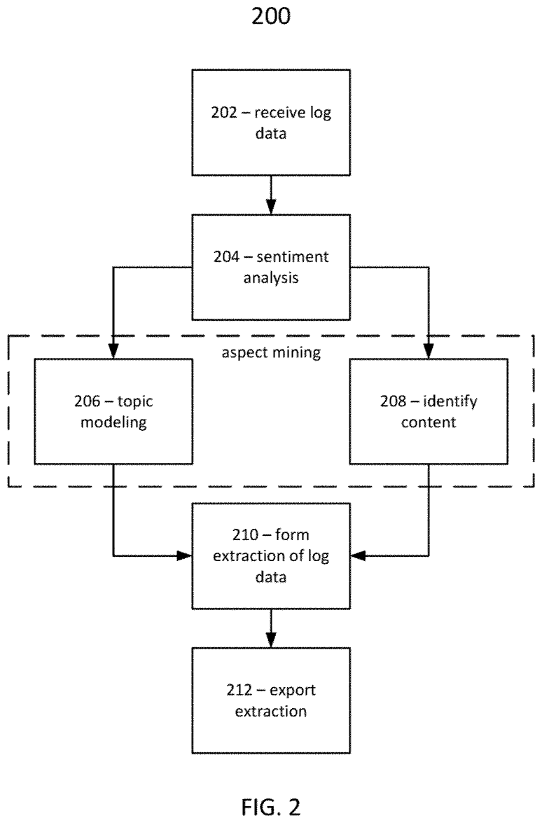

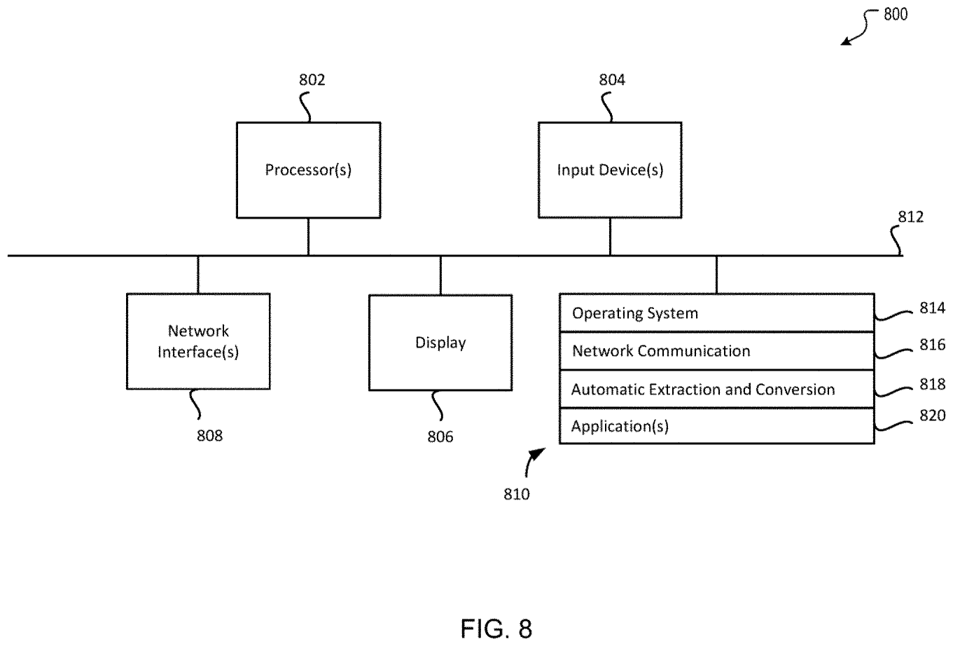

FIG. 1 shows an example automatic extraction and conversion system according to some embodiments of the disclosure. System 100 may include a variety of hardware, firmware, and/or software components that interact with one another and with user devices 10A/10B and/or chat servers 20. For example, system 100 includes a network transceiver or other chat data intake system 110, sentiment processing 120, content processing 130, topic processing 140, and/or export processing 150, each of which may be implemented by one or more computers (e.g., as described below with respect to FIG. 8). As described in detail below, user devices 10A and 10B can use chat app(s) to communicate with one another (e.g., through the Internet or another network or networks). The chat app(s) generate chat logs comprising a record of the conversation between users of user devices 10A and 10B. These logs may be stored locally on user device 10A and/or 10B, in the cloud (e.g., by chat server 20), or both. Chat data intake receives chat logs for analysis. Sentiment processing 120, content processing 130, and topic processing 140 can analyze the chat logs and identify data relevant to application(s) 30A/30B. Export processing 150 can configure such data for use by application(s) 30A/30B and provide the data to application(s) 30A/30B. For example, application(s) 30A/30B can be executed by one or more of the user devices 10A/10B, system 100, or any other computing devices. FIGS. 2-7 illustrate the functioning of system 100 in detail.

User devices 10A/10B, chat server 20, system 100, and individual elements of system 100 (chat data intake system 110, sentiment processing 120, content processing 130, topic processing 140, and export processing 150) are each depicted as single blocks for ease of illustration, but those of ordinary skill in the art will appreciate that these may be embodied in different forms for different implementations. For example, system 100 may be provided by a single device or plural devices, and/or any or all of its components may be distributed across multiple devices. In another example, while network transceiver or other chat data intake system 110, sentiment processing 120, content processing 130, topic processing 140, and export processing 150 are depicted separately, any combination of these elements may be part of a combined hardware, firmware, and/or software element. Moreover, while two user devices 10 and one chat server 20 are shown, in practice, there may be more user devices 10 (e.g., in the context of a group chat), multiple chat servers 20, or both.

FIG. 2 shows an example automatic extraction and conversion process 200 according to some embodiments of the disclosure. System 100 can perform process 200 to extract data from chat logs and prepare that data for use with other applications.

At 202, system 100 can receive log data generated by a chat application. As shown in FIG. 1, the log data can be sent from one of the user devices 10 and/or from the chat server 20. Network transceiver or other chat data intake system 110 can receive the log data from one or more of these sources. The log data includes at least a text record of a chat conversation, generated and stored by the chat app.

In some embodiments, log data is only made available to system 100 with permission from one or both of the chat participants. For example, a user of a chat application on one of the user devices 10 can actively choose to send the log data to system 100 or opt in to permission to send the log data.

At 204, system 100 can perform sentiment analysis, for example using sentiment processing 120. Sentiment analysis can serve as a first filter for determining whether there is relevant information in the chat log. For example, sentiment analysis can identify at least one positive sentiment in at least one portion of the log data using an ML process, such as a Naïve bayes or other supervised process trained to identify positive and negative sentiments in text. For example, the ML algorithm used for sentiment analysis may be a MultinomialNB classifier or similar algorithm.

A positive sentiment can indicate, for example, that a transaction was agreed upon, an event happened, etc. A negative sentiment can indicate that there was no transaction or event, for example. Thus, in the case of a positive sentiment, processing 200 may advance, whereas in the case of a negative sentiment, processing 200 may end. If a positive sentiment is found, at least one portion of the log data containing the positive sentiment can be further processed as described below. In some embodiments, the entire log data may be processed.

In some embodiments, the positive sentiment in the chat log may be above a threshold, rather than being totally positive. For example, a buyer may not be happy paying a large amount of money, and the chat log might show the buyer has a negative sentiment about that aspect of the transaction. Indeed, the chat log may show haggling which could appear as negative to the sentiment analysis algorithm. But in the end, the transaction may still be completed, which could be demonstrated by an overall positivity in the chat sentiment.

At 206, system 100 can perform topic modeling, for example using topic processing 140. Topic modeling can identify topic data in the at least one portion of the log data using an ML process. Topic data can be data that is sought as being relevant to a transaction (e.g., item name, product name, price, words indicating a transaction is complete, etc.). This ML process can be different from that used for sentiment analysis. For example, topic modeling can perform unsupervised classification of the log data using Latent Dirichlet Allocation (LDA) or other algorithms with models trained on libraries of chat topic words. This unsupervised classification finds natural groups of items (e.g., topics) even when the topics are not known in advance.

At 208, system 100 can perform named entity recognition (NER), for example using content processing 130. NER can identify content of the at least one portion of the log data using an ML process. This can be a natural language processing (NLP) process trained to identify content relevant to a function of the external application. For example, the ML process may be a NER algorithm such as spaCy, NLTK, open NLP, etc. The ML process may use grammar-based rules to identify specific types of content. The ML process may use one or more models (e.g., supervised learning ML models) trained to identify one or more specific types of content. In some cases, system 100 may use bidirectional encoder representations from transformers (BERT) as an ML process for performing NER. For example, a BERT model can be trained to recognize customer identifiers (e.g., name, customer ID, mobile phone number, etc.), items common to business transactions (e.g., items for sale, terms of sale, etc.), or any content of interest.

In some embodiments, processing at 204-208 may be regarded together as “aspect mining.” Aspect mining can identify an aspect of the at least one portion of the log data. Aspects may include, for example, parts of speech, and identifying such aspects can help identify transitions in a chat flow (e.g., business discussion to transaction transition). Identifying the aspect can include at least one of matching one or more predefined words within the at least one portion of the log data, identifying a graphic within the at least one portion of the log data, identifying a part of speech within the at least one portion of the log data, and determining an order of words within the at least one portion of the log data.

For example, aspect mining may include Aspect-Based Opinion Mining (ABOM), as is known to those of ordinary skill in the art. ABOM involves extracting aspects or features of an entity and figuring out opinions about those aspects. ABOM is a method of text classification that has evolved from sentiment analysis and NER. ABOM is thus a combination of aspect extraction (e.g., topic modeling and/or NER) and opinion mining (e.g., sentiment analysis). While opinions about entities are useful, opinions about aspects of those entities may be more granular and insightful. Consider the example of “ice cream” as the entity. Aspects or features of this entity include flavor, temperature, taste, presentation, etc. A person may express that he disliked the ice cream, but this is expressing opinion on the overall entity. ABOM analysis may find that the person liked the flavor and the presentation but didn't like the taste.

ABOM can be used to find out features or characteristics of entities extracted by NER. There are some automated aspect extractor APIs that may be used and trained. Selecting and training aspects may include approaches such as aggregate score of opinion words, SentiWordNet, aspect table, dependency relations, and/or emotion analysis using lexicon and semantic representation. ABOM may employ a rule-based approach where frame certain rules to identify most used words. These are further analyzed and processed. A dictionary-based approach can curate common words of aspect terms for further classification according to various domains.

Topic modeling and NER can be performed in parallel (e.g., concurrently, as a combined aspect mining process) after sentiment analysis at 204. In some embodiments, at least one of the identifying the content and the identifying the aspect comprises processing the topic data in addition to the at least one portion of the log data. In other words, NER and/or aspect mining can use the output of topic modeling (i.e., identified topics) to refine their own processing. For example, data identifying the topic(s) of conversation in a chat can help the NER process identify relevant content and/or help aspect mining identify actionable words. Using the spaCy NER default model, for example, system 100 can recognize different entities like item name, product name, etc. as datasets. Apart from these default entities, spaCy enables the addition of arbitrary classes to the entity recognition model by training the model to update it with newer trained examples. For each text input on which the model is tested, system 100 may calculate the accuracy score, precision, recall and f-score for each entity that the model recognizes. System 100 may sum up and average the values of these metrics for each entity to generate an overall score to evaluate the model on the test data.

At 210, system 100 can form an extraction of the log data that includes at least a portion of the content, at least a portion of the aspect, and at least a portion of the topic data. The extraction can have a format processed by an external application different from the chat application. For example, if the extraction is to be processed by a spreadsheet application, the data may be formatted as a sheet (e.g., .xls or .xlsx) with tags related to transaction data. In another example, if the extraction is to be processed by an accounting or financial management application, it may be formatted into a native document or data format for such an application. Data may also be formatted as JSON data consumable by a variety of web-oriented applications and/or other applications.

At 212, system 100 can export the extraction to the external application. For example, system 100 can store the extraction in a location accessible to the external application and/or trigger the external application to load and process the extraction. Thereafter, the extraction may be processed using the external application.

As a non-limiting example to demonstrate how the extraction and conversion process 200 works in some embodiments, the following explanation of FIG. 2 is presented in the context of extracting transaction data from a chat wherein a transaction between a buyer and a seller took place. As such, in this example, at least one of the content, the aspect, and the topic data relate to a transaction, and the external application comprises at least one of an accounting application, a financial application, and a spreadsheet application. However, it will be appreciated that process 200 can be applied to extract and convert other data from chat logs as well.

At 202, system 100 can receive log data that represents a chat between a fruit merchant and a potential buyer of fruit. For example, the fruit merchant may upload the log data from her user device 10A to system 100 for processing. The log data in this example includes the following discussion (perhaps among other things):
BUYERNAME: What do you have in stock today?
SELLERNAME: We have mangos for $1 each, bananas for $2/bunch, ghost chilies for $5/lb.
BUYERNAME: I am interested in mangos, do you have many available?
SELLERNAME: Yes we have dozens.
BUYERNAME: I would like 10 mangos.
SELLERNAME: OK, please send $10 to my PayPal account.
BUYERNAME: Done!
SELLERNAME: Thanks! The mangos will be ready for you to pick up at 2:00 today.

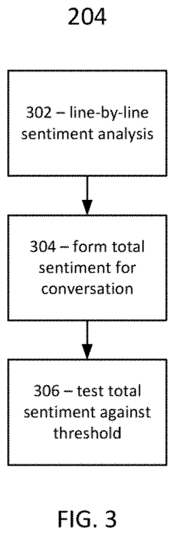

At 204, system 100 can perform sentiment analysis on the log data. For example, FIG. 3 shows a sentiment analysis process 204 according to some embodiments of the disclosure.

At 302, system 100 can perform a line-by-line sentiment analysis on the conversation. The trained ML model can determine, based on the language in a given line, how positive the sentiment is therein. For example, in the above text, “interested,” “yes,” “OK,” “please,” “thanks,” etc. may contribute to positive sentiment scoring for lines that contain such words. Scores may be expressed as numeric values or classifications (e.g., positive or negative).

At 304, system 100 can form a total sentiment score for the conversation. For example, numeric scores for each line from 302 can be summed, or an overall classification can be derived from line-by-line classifications (e.g., taking the most frequently observed classification as the total classification for the conversation).

At 306, system 100 can compare the sentiment score with one or more threshold levels to determine whether the overall sentiment expressed in the conversation is positive. In some embodiments, multiple threshold levels can be established to provide a fine-grained classification (e.g., very positive, positive, neutral, negative, very negative). Each level can have a sentiment score range or cutoff threshold value associated therewith, such that if the score from 304 is within a given range or above or below a given threshold value, system 100 can classify it as belonging to the associated classification. For example, in the above text, system 100 may identify a positive sentiment. Specifically, an analysis of the sample chat text above by the ML algorithm may yield a positive rating with 71% accuracy. As the ML model is trained with more words and conversations, accuracy levels may improve. If the sentiment for the conversation is positive or very positive, processing can continue as described below.

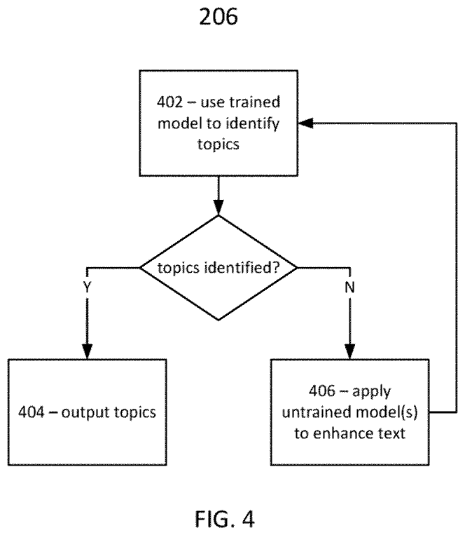

At 206, system 100 can perform topic modeling on the log data. For example, FIG. 4 shows a topic modeling process 206 according to some embodiments of the disclosure.

At 402, system 100 can apply a trained ML model to the text to attempt to identify topic information in the conversation. For example, this can include the type of merchant or transaction. In this example, the presence of “mangos,” “bananas,” and “ghost chiles” can indicate that the merchant in question is a fruit merchant or grocer. However, there may be cases where the model does not identify a clear topic. For example, the buyer and seller may have had a casual conversation about the weather or traffic before conducting business, or the item being purchased may have only been mentioned once. If a clear topic is identified, processing may proceed to 404. If not, processing may proceed to 406.

If the topic was successfully identified, at 404, system 100 can output the topic as part of the extraction. In the present example, this may be a transaction category of “fruit” or “groceries” or the like. In some cases, topic modeling can also identify the cost and/or item (e.g., $10 for 10 mangos).

If the topic was no successfully identified, at 406, system 100 can enhance the text with an untrained ML process. For example, system 100 can use an untrained part of speech analysis algorithm, word frequency algorithm, combination thereof, or other algorithm to add additional data (e.g., part of speech labels or filtering by word frequency). Then, the enhanced text can be processed again at 402 to identify a topic.

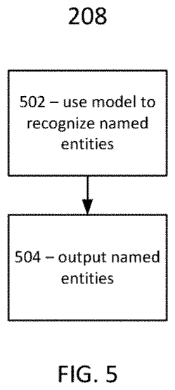

At 208, system 100 can perform NER on the log data. For example, FIG. 5 shows a content identification process 208 according to some embodiments of the disclosure.

At 502, system 100 can use an ML model to identify named entities in the text. The ML model performs NER, which can identify data such the buyer name, items bought, PayPal as payment method, seller name or company, etc.

At 504, system 100 can output the named entities as part of the extraction. In the present example, this may be a buyer name, seller name (or company), etc.

In some practical applications, some or all of the above processing may be performed concurrently by a combined aspect mining algorithm or suite. For example, system 100 can use spaCy's dependency parser, which can perform the above-described processing to identify different aspects of the text as fruit and cost, and also identify emotion or opinion around it (e.g., the buyer has positive sentiment and is buying the product).

After all this is complete, system 100 will have at least the customer name/chat ID (BUYERNAME), items bought (10 mangos), and cost of items ($10 total, or $1 per mango*10). At 210, system 100 can extract this data as described above, and at 212, system 100 can provide the extraction to another application such as a spreadsheet, financial application, accounting application, inventory tracking application, etc.

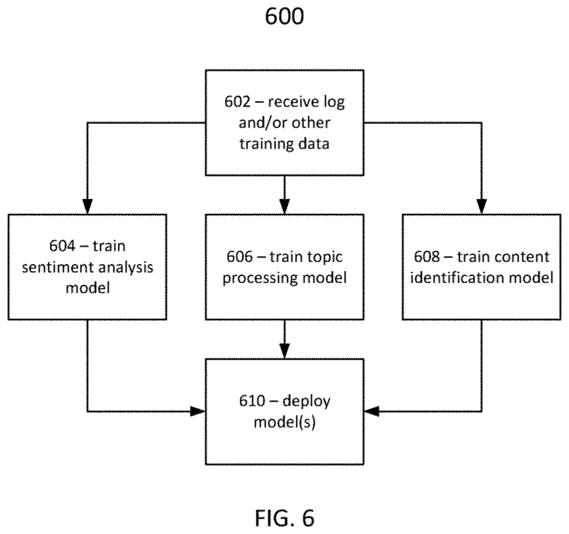

FIG. 6 shows an example training process 600 according to some embodiments of the disclosure. System 100 can perform process 600 to prepare models used for sentiment analysis, topic modeling, and/or NLP as described above. Note that while FIG. 6 shows each model being trained as part of a single process 600 for ease of illustration, in other embodiments the training of respective models may be performed independently.

At 602, system 100 can receive log data for training and/or other training data. For example, the training data can include a corpus of chat log records or other training text. The training data can be labeled or unlabeled, depending on whether the ML model to be trained uses supervised or unsupervised learning. In some cases, system 100 can receive both labeled and unlabeled data, allowing it to train both supervised and unsupervised models. Labels can include sentiment labels, content labels (e.g., labels of customer identifiers, items common to business transactions, or any content of interest), and/or other labels.

At 604, system 100 can train a model used for sentiment analysis (e.g., sentiment analysis 204 described above). For example, system 100 can use training data received at 602 that has been labeled to indicate sentiment in the text to train a Naïve bayes or other supervised ML model to identify positive and negative sentiments in text. System 100 can use standard ML training procedures where all parameters are updated in one training process and/or can use online learning procedures wherein each parameter of the model is trained and updated one by one with multiple training passes.

At 606, system 100 can train a model used for topic modeling (e.g., topic modeling 206 described above). For example, system 100 can use unlabeled training data received at 602, such as a corpus of chat logs, libraries of chat topic words, or other vocabulary data or other text, to train a Latent Dirichlet Allocation (LDA) or other unsupervised ML model to identify topics in text. System 100 can use standard ML training procedures where all parameters are updated in one training process and/or can use online learning procedures wherein each parameter of the model is trained and updated one by one with multiple training passes.

At 608, system 100 can train a model used for content identification (e.g., NER 208 described above). For example, system 100 can use training data received at 602 that has been labeled to indicate customer identifiers (e.g., name, customer ID, mobile phone number, etc.), items common to business transactions (e.g., items for sale, terms of sale, etc.), or any content of interest to train a NER algorithm such as spaCy, NLTK, open NLP, etc. to identify such labeled content. System 100 can use standard ML training procedures where all parameters are updated in one training process and/or can use online learning procedures wherein each parameter of the model is trained and updated one by one with multiple training passes.

At 610, system 100 can deploy the models trained as described above. For example, the models can be stored in memory of system 100 and/or a machine learning platform (e.g., a component of system 100, a separate component accessible to system 100, a cloud-based service, etc.). When process 200 is run, the trained models can be deployed in the ML processing of process 200 as described above.

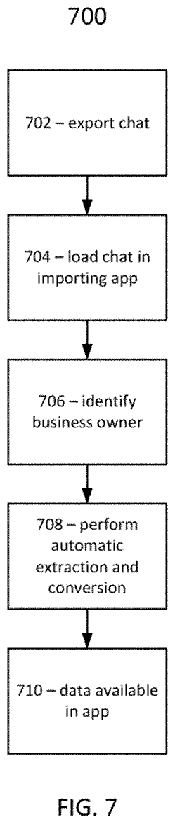

FIG. 7 shows an example user interface (UI) interaction process 700 according to some embodiments of the disclosure. System 100 can perform process 700 to provide the functionality described above to users through one or more UIs.

At 702, system 100 can perform processing to export a chat from the chat source application. For example, a UI of the chat application may have an option to export the data. In some cases, this may be a built-in feature of a chat application. In some embodiments, software for performing at least part of process 200 as described above may be installed on a same computing device as the device with the chat application, and the installation of the former may cause a UI option for exporting chat data to be available in the latter. In some embodiments, the exported chat data may be saved as a file in a memory of the device executing the chat application, or in a memory accessible thereto such as a cloud storage.

At 704, system 100 can load the exported chat data into a specialized application for performing process 200 and/or into an application which will ultimately use the data generated (e.g., an accounting application, a spreadsheet application, etc.). For example, a UI element within the application may allow a user to select the file saved at 702 for loading. In some embodiments, such as when both the application that will perform process 200 and the chat application are running concurrently, processing at 702 may automatically cause the former application to load the chat data exported at 702.

At 706, system 100 can identify the business owner within the chat data. For example, system 100 may perform at least enough of process 200 to extract the names of chatters from the chat record (e.g., performing topic modeling or NER or a combination thereof). The extracted names may be presented in a UI element, so that the user can indicate which is the business owner or seller (or buyer, in other embodiments). For example, if “Lemmy” and “Slash” are the names of the two chatters, both names will be shown in the UI element, and the user can pick one as the business owner (e.g., “Lemmy”). In some cases, the business owner or seller (or buyer, in other embodiments) may be predefined (e.g., the user can enter a default name that is always the business owner in uploaded chats).

At 708, system 100 can complete automatic extraction and conversion. For example, system 100 may perform some or all of process 200, as described above.

At 710, the extracted data becomes available in the application. For example, in an accounting application, the business transaction recorded in the chat data may be translated into an invoice by built-in invoice generating capabilities already present in the accounting application. In another example, in a spreadsheet application, the business transaction recorded in the chat data may populate a spreadsheet formed according to the built-in sheet generating capabilities already present in the spreadsheet application.

FIG. 8 shows a computing device 800 according to some embodiments of the disclosure. For example, computing device 800 may function as system 100 or any portion(s) thereof, or multiple computing devices 800 may function as system 100.

Computing device 800 may be implemented on any electronic device that runs software applications derived from compiled instructions, including without limitation personal computers, servers, smart phones, media players, electronic tablets, game consoles, email devices, etc. In some implementations, computing device 800 may include one or more processors 802, one or more input devices 804, one or more display devices 806, one or more network interfaces 808, and one or more computer-readable mediums 810. Each of these components may be coupled by bus 812, and in some embodiments, these components may be distributed among multiple physical locations and coupled by a network.

Display device 806 may be any known display technology, including but not limited to display devices using Liquid Crystal Display (LCD) or Light Emitting Diode (LED) technology. Processor(s) 802 may use any known processor technology, including but not limited to graphics processors and multi-core processors. Input device 804 may be any known input device technology, including but not limited to a keyboard (including a virtual keyboard), mouse, track ball, and touch-sensitive pad or display. Bus 812 may be any known internal or external bus technology, including but not limited to ISA, EISA, PCI, PCI Express, NuBus, USB, Serial ATA or FireWire. In some embodiments, some or all devices shown as coupled by bus 812 may not be coupled to one another by a physical bus, but by a network connection, for example. Computer-readable medium 810 may be any medium that participates in providing instructions to processor(s) 802 for execution, including without limitation, non-volatile storage media (e.g., optical disks, magnetic disks, flash drives, etc.), or volatile media (e.g., SDRAM, ROM, etc.).

Computer-readable medium 810 may include various instructions 814 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 804; sending output to display device 806; keeping track of files and directories on computer-readable medium 810; controlling peripheral devices (e.g., disk drives, printers, etc.) which can be controlled directly or through an I/O controller; and managing traffic on bus 812. Network communications instructions 816 may establish and maintain network connections (e.g., software for implementing communication protocols, such as TCP/IP, HTTP, Ethernet, telephony, etc.).

Automatic extraction and conversion 818 may include the system elements and/or the instructions that enable computing device 800 to perform the processing of system 100 as described above. Application(s) 820 may be an application that uses or implements the outcome of processes described herein and/or other processes. For example, application(s) 820 may use data extracted from chat logs (e.g., to perform spreadsheet, financial, accounting, and/or other processing) as described above. In some embodiments, the various processes may also be implemented in operating system 814.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API and/or SDK, in addition to those functions specifically described above as being implemented using an API and/or SDK. An API may define one or more parameters that are passed between a calling application and other software code (e.g., an operating system, library routine, function) that provides a service, that provides data, or that performs an operation or a computation. SDKs can include APIs (or multiple APIs), integrated development environments (IDEs), documentation, libraries, code samples, and other utilities.

The API and/or SDK may be implemented as one or more calls in program code that send or receive one or more parameters through a parameter list or other structure based on a call convention defined in an API and/or SDK specification document. A parameter may be a constant, a key, a data structure, an object, an object class, a variable, a data type, a pointer, an array, a list, or another call. API and/or SDK calls and parameters may be implemented in any programming language. The programming language may define the vocabulary and calling convention that a programmer will employ to access functions supporting the API and/or SDK.

In some implementations, an API and/or SDK call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A method comprising:
receiving, by a processor, log data generated by a chat application;
identifying, by the processor, at least one positive sentiment in at least one portion of the log data using a first machine learning (ML) process;
in response to identifying the at least one positive sentiment, identifying, by the processor, content of the at least one portion of the log data that is relevant to an external application different from the chat application using a second ML process;
in response to identifying the at least one positive sentiment, identifying, by the processor, topic data in the at least one portion of the log data using a third ML process;
forming, by the processor, an extraction of the log data that includes at least a portion of the content and at least a portion of the topic data, the extraction having a format processed by the external application different from the chat application; and
exporting, by the processor, the extraction to the external application.

2. The method of claim 1, wherein the first ML process comprises a MultinomialNB classifier or other supervised process trained to identify positive and negative sentiments in text.

3. The method of claim 1, wherein the second ML process comprises a natural language processing (NLP) process trained to identify the content.

4. The method of claim 1, wherein identifying the content, identifying the topic data, or a combination thereof comprises at least one of matching one or more predefined words within the at least one portion of the log data, identifying a graphic within the at least one portion of the log data, identifying a part of speech within the at least one portion of the log data, and determining an order of words within the at least one portion of the log data.

5. The method of claim 1, wherein the third ML process comprises a Latent Dirichlet Allocation (LDA) algorithm or other unsupervised learning process trained to identify topics from chat terms.

6. The method of claim 1, wherein identifying the content comprises processing the topic data in addition to the at least one portion of the log data.

7. The method of claim 1, further comprising processing, by the processor, the extraction using the external application.

8. The method of claim 1, wherein:
at least one of the content and the topic data relate to a transaction; and
the external application comprises at least one of an accounting application, a financial application, and a spreadsheet application.

9. A method comprising:
training, by a processor, at least one of a first machine learning (ML) process, a second ML process, and a third ML process, wherein:
the first ML process is configured to identify a positive sentiment in text data,
the second ML process is configured to identify content of the text data that is relevant to an external application different from the chat application, and
the third ML process is configured to identify topic data in the text data;
processing, by the processor, log data generated by a chat application using the first ML process, the second ML process, and the third ML process;
forming, by the processor, an extraction of the log data from the outcome of the processing, the extraction having a format processed by the external application; and
exporting, by the processor, the extraction to the external application.

10. The method of claim 9, wherein the processing comprises:
identifying, by the processor, at least one positive sentiment in at least one portion of the log data using the first ML process;
identifying, by the processor, content of the at least one portion of the log data using the second ML process; and
identifying, by the processor, topic data in the at least one portion of the log data using the third ML process.

11. The method of claim 9, wherein the training comprises unsupervised training using a corpus of chat log records.

12. The method of claim 9, wherein the training comprises supervised training using labeled sentiment data, vocabulary data, or a combination thereof.

13. A system comprising:
a transceiver configured to receive log data generated by a chat application from a network source; and
a processor in communication with the transceiver and being configured to perform processing comprising:
identifying at least one positive sentiment in at least one portion of the log data using a first machine learning (ML) process;
in response to identifying the at least one positive sentiment, identifying content of the at least one portion of the log data that is relevant to an external application different from the chat application using a second ML process;
in response to identifying the at least one positive sentiment, identifying topic data in the at least one portion of the log data using a third ML process;
forming an extraction of the log data that includes at least a portion of the content and at least a portion of the topic data, the extraction having a format processed by the external application; and
exporting the extraction to the external application.

14. The system of claim 13, wherein the first ML process comprises a MultinomialNB classifier or other supervised process trained to identify positive and negative sentiments in text.

15. The system of claim 13, wherein the second ML process comprises a natural language processing (NLP) process trained to identify the content.

16. The system of claim 13, wherein identifying the content, identifying the topic data, or a combination thereof comprises at least one of matching one or more predefined words within the at least one portion of the log data, identifying a graphic within the at least one portion of the log data, identifying a part of speech within the at least one portion of the log data, and determining an order of words within the at least one portion of the log data.

17. The system of claim 13, wherein the third ML process comprises a Latent Dirichlet Allocation (LDA) algorithm or other unsupervised learning process trained to identify topics from chat terms.

18. The system of claim 13, wherein identifying the content comprises processing the topic data in addition to the at least one portion of the log data.

19. The system of claim 13, wherein the processor is further configured to execute the external application, wherein executing the external application comprises processing the extraction using the external application.

20. The system of claim 13, wherein:
at least one of the content and the topic data relate to a transaction; and
the external application comprises at least one of an accounting application, a financial application, and a spreadsheet application.
